(19) United States
(12) Patent Application Publication
(10) Pub. No.: US 2019/0110638 A1
(43) Pub. Date: Apr. 18, 2019

(54) MACHINE LEARNING CONTROL OF COOKING APPLIANCES

(71) Applicant: MIDEA GROUP CO., LTD, Foshan (CN)

(72) Inventors: Xiaochun Li, San Jose, CA (US); Hua Zhou, San Jose, CA (US); Jianliang Ma, Foshan (CN); Yue Zhang, Foshan (CN)

(21) Appl. No.: 15/578,677

(22) PCT Filed: Oct. 16, 2017
(86) PCT No.: PCT/CN2017/106354

§ 371 Date: Nov. 30, 2017

(51) Int. Cl. A47J 36/32; G06N 99/00; F24C 15/00; F24C 15/04; A23L 5/10

(52) U.S. Cl. CPC A47J 36/32; G06N 99/005; A23V 2002/00; F24C 15/04; A23L 5/10; F24C 15/008

(57) ABSTRACT

A cooking appliance uses machine learning models to provide better automation of the cooking process. As one example, a cooking appliance has a cook chamber in which food is placed for cooking. A camera is positioned to view an interior of the cook chamber. When food is placed inside the cook chamber, the camera captures images of the food. From the images, the machine learning model determines various attributes of the food, such as the type of food and/or the amount of food, and the cooking process is controlled accordingly. The machine learning model may be resident in the cooking appliance or it may be accessed via a network.

### TECHNICAL FIELD

This disclosure relates generally to control of cooking appliances.

### DESCRIPTION OF RELATED ART

Cooking appliances are designed to be versatile. Many appliances can cook many different types of food in many different ways. An oven might have the capability to broil steaks, bake fish, roast a turkey, bake pies and cakes, roast vegetables, bake pizzas, cook pre-packaged foods and warm up leftovers, just to name a few examples. However, a typical appliance does not have many controls. The user might be able to select the cooking mode broil or bake), time and temperature, but not much more. Thus, a user might set an oven to 350 degrees for 45 minutes. Once set, the appliance blindly carries out the user's instructions, without regard to what food is being cooked, whether the user's instructions will obtain the desired result, or whether the food is over- or under-cooked at the end of the cooking time.

The responsibility for selecting the best cooking process is the user's responsibility, as is the responsibility for monitoring the food as the cooking progresses. For users who are not skilled at cooking, this can be both intimidating and frustrating.

Thus, there is a need for more intelligent cooking appliances.

### SUMMARY

The present disclosure provides cooking appliances that use machine learning models to provide better automation of the cooking process. As one example, a cooking appliance has a cook chamber in which food is placed for cooking. A camera is positioned to view an interior of the cook chamber. When food is placed inside the cook chamber, the camera captures images of the food. From the images, the machine learning model determines various attributes of the food, such as the type of food and/or the amount of food, and the cooking process is controlled accordingly. The machine learning model may be resident in the cooking appliance or it may be accessed via a network.

This process may be used to set the initial cooking process for the appliance, including selection of the proper cooking mode and setting the temperature-time curve for cooking. It may also be used to automatically adjust the cooking process as cooking progresses. Control of the cooking process can also be based on user inputs, temperature sensing and other sensor data, user usage history, historical performance data and other factors.

Other aspects include components, devices, systems, improvements, methods, processes, applications, computer readable mediums, and other technologies related to any of the above.

### BRIEF DESCRIPTION OF THE DRAWINGS

Embodiments of the disclosure have other advantages and features which will he more readily apparent from the following detailed description and the appended claims, when taken in conjunction with the accompanying drawings, in which:

FIG. 1 is a cross-section of a side view of an oven, according to an embodiment.

FIG. 2 is a block diagram illustrating control of an oven, according to an embodiment.

FIG. 3 is a flow diagram illustrating training and operation of a machine learning model, according to an embodiment.

FIG. 4 is a block diagram of a residential environment including a cooking appliance, according to an embodiment.

FIG. 5 is a photograph of a cooking appliance, according to an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION OF THE PREFERRED EMBODIMENTS

The figures and the following description relate to preferred embodiments by way of illustration only. It should be noted that from he following discussion, alternative embodiments of the structures and methods disclosed herein will be readily recognized as viable alternatives that may be employed without departing from the principles of what is claimed.

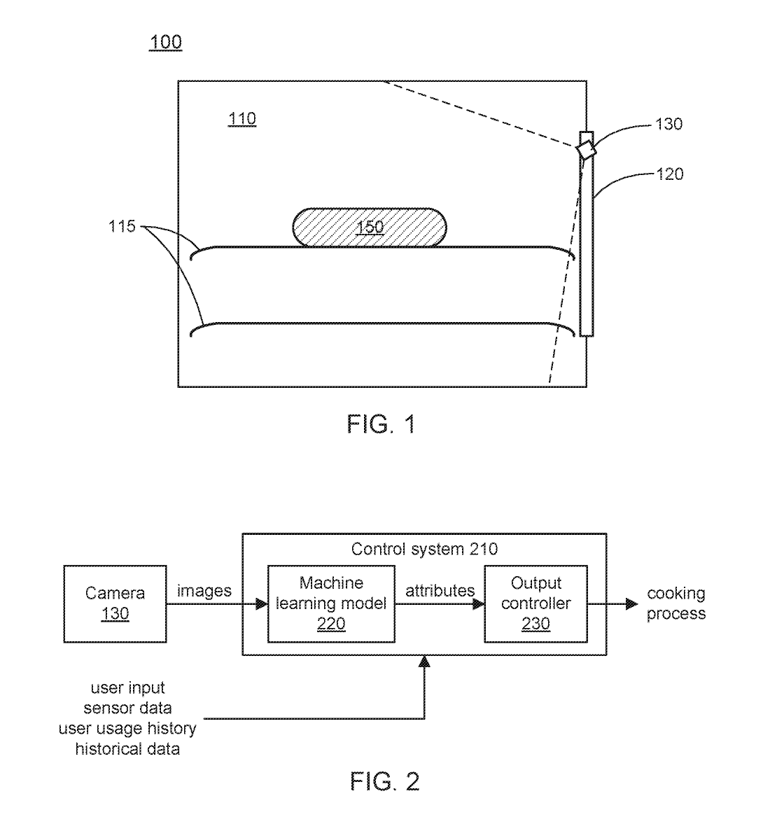

FIG. 1 is a cross-section of a side view of an oven 100 according to an embodiment. The oven 100 includes a cook chamber 110 with a front door 120. Food 150 is placed in the cook chamber 110 for cooking. Racks 115 can be positioned at various heights in the cook chamber 110. The food 150 can be placed on a rack 115. Food can also be held on a rotisserie (not shown). The food 150 can also be placed on/in a receptacle, such as a casserole dish, roasting pan, cast iron pan, broiler pan, Dutch oven, cookie sheet, cupcake pan, bundt pan, soufflé dish, pizza stone or pizza steel, etc. There can also be other accessories inside the oven, such as a rotisserie or drippings pan.

The oven 100 includes a camera 130 positioned to view the interior of the cook chamber 110. In this example, the front door 120 includes a double pane window and the camera 130 is located between the two panes of the window. In this way, the camera 130 is isolated from the external environment, thus reducing possible damage by the user. It also is not directly in the cook chamber 110. This provides some thermal isolation, so that the camera 130 is not exposed to the same high temperatures as the interior of the cook chamber. Here, the camera 130 is located toward the top of the door 120, but tilted downwards to view the cook chamber. The camera's field of view is shown by the dashed lines. From this position, if a steak 150 is on one of the racks, the camera 130 can view both the top of the steak and the side of the steak. The top view is useful to identify that the food in the cook chamber is a steak, as well as helping to determine the size of the steak. The side view is useful to determine the thickness of the steak, which is an important factor in determining the correct cooking time. The front window may also include an optical coating to reduce ambient light in the cooking chamber, thus enabling the camera to capture better quality images. The optical coating can act like a one-way mirror, preventing ambient light from entering the chamber while still allowing the user to see into the chamber. The cooking chamber may also include special lighting or a special light hood to provide more even lighting of the interior for the camera.

FIG. 2 is a block diagram illustrating control of the oven 100. The control system 210 is roughly divided into a machine learning model 220 and an output controller 230. The machine learning model 220 receives images captured by the camera 130.

From these inputs (possibly in combination with other additional inputs), the machine learning model 220 determines various attributes of the contents of the cook chamber. In one embodiment, it determines the type of food from the images and controls the cooking process based on the food type. For example, basic food categories might include poultry, meat, seafood, baked goods and vegetables. These will be cooked differently, including using different temperatures and times during the cooking process. Within meat, beef, pork, veal and lamb have different safe cooking temperatures and different acceptable ranges of final temperatures. Within beef, different cuts such as boneless steaks, bone-in steaks, ribs, shank and brisket also should be cooked according to different temperature-time curves. Chicken is one type of poultry. Within chicken, different parts such as whole chicken, butterflied chicken, legs, thighs, breasts and wings are also cooked differently. In one approach, the machine learning model 220 is trained to identify different food types from a list, which may expand and change over time.

Another possible attribute determined by the machine learning model is the cooking load. Different measures are applicable depending on the type of food. For steaks, the size and thickness of the steak may determine the temperature and cooking time. For chicken drumsticks, the number of drumsticks may affect the cooking load. For a cake, the volume of the initial cake batter or the size of the cake pan may be relevant. For some foods, the weight may be relevant. This can be determined by a scale included with the product.

The rack position and receptacle, if any, can also affect the cooking process. Broiling is usually performed using the rack in the top position. If the machine learning model determines that broiling should be used but the rack is not e top position, the oven could instruct the user to reposition the rack. Other recipes may also be designed for specific rack positions, for example if a crust is preferred on the top or bottom of the food. Receptacles that affect heat distribution, such as Dutch ovens, cast iron pans, and pizza stones or pizza steels, typically will influence the cooking process.

The output controller 230 controls the cooking process for the food according to the attributes determined by the machine learning model 220. One aspect controlled by the output controller 230 typically is the temperature-time curve for cooking the food. Based on the type of food and the amount of food, the controller 230 can select the right temperature and the right cooking time. Furthermore, rather than cooking at a constant temperature for a certain amount of time (e.g., 350 degrees for 45 minutes), the controller may specify a temperature-time curve that varies the temperature as a function of time. For example, for steaks, you typically want to seal the juice inside. Accordingly, the initial cooking temperature may be very high to sear the exterior, followed by lower cooking temperature to allow the heat to distribute inside the steak.

The controller may also take other factors into consideration, such as user inputs, or temperature monitoring of the cook chamber or of the food. For steaks, the user's preference of rare, medium or well-done will influence the temperature-time curve. In addition, the cooking can be actively monitored based on monitoring the temperature of the cook chamber or of the food. If a meat thermometer indicates the steak has reached the correct internal temperature, the controller may end the cooking process even if the allotted cooking time has not been reached. Control of the cooking process can also be based on other types of sensor data, the user's usage history and/or historical performance data.

In addition to the temperature-time curve, the controller 230 may also adjust other quantities. For example, if the cooking appliance has different cooking modes, the controller may select the correct cooking mode for the detected food. Examples of cooking modes include bake, roast, and broil. More sophisticated cooking modes are possible. For example, bake may be subdivided into regular bake (which heats the food from below), convection bake (same as regular bake but with active air circulation), surround bake (heat from both above and below), browning bake (heat from above). Roast can be similarly subdividied. Additional cooking modes include rotisserie, dehydrating, proofing (rising dough), and defrost. If the cooking process has different phases, such as defrosting, roasting, and finishing, the controller may determine when to transition from one phase to the next. The controller can also provide notification when the cooking process is completed. It may also provide notification if the cook chamber is empty, for example if the user starts cooking but the chamber is actually empty. Conversely, if the user is preheating the chamber, the controller may provide notification is something is inside the chamber during the preheating process.

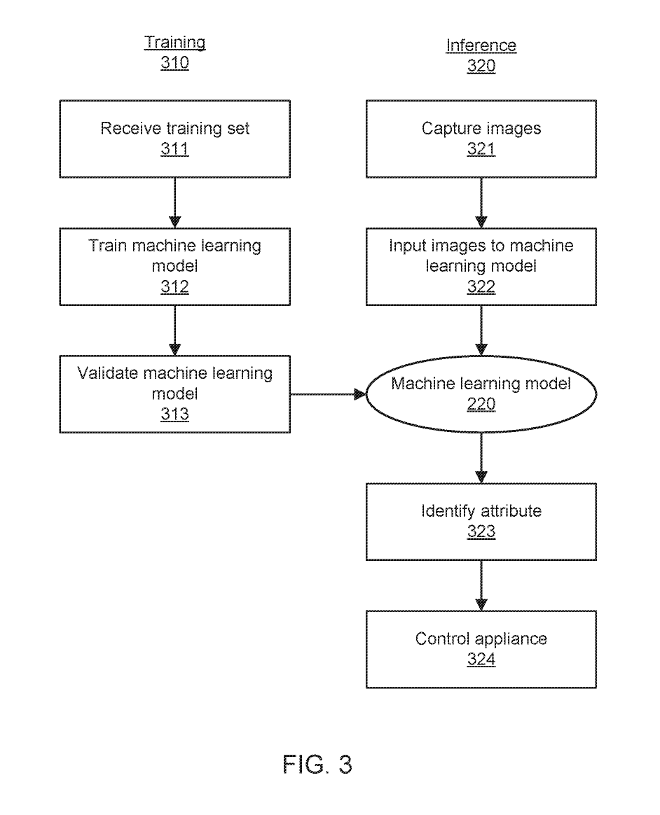

FIG. 3 is a flow diagram illustrating training and operation of a machine learning model 220, according to an embodiment. The process includes two main phases: training 310 the machine learning model 220 and inference (operation) 320 of the machine learning model 220.

A training module (not shown) performs training 310 of the machine learning model 220. In some embodiments, the machine learning model 220 is defined by an architecture with a certain number of layers and nodes, with biases and weighted connections (parameters) between the nodes. During training 310, the training module determines the values of parameters weights and biases) of the machine learning model 220, based on a set of training samples.

The training module receives 311 a training set for training. The training samples in the set includes images captured by the camera 130 for many different situations: different foods; different amounts of food; different positions of the food in the chamber, on the rack on in a receptacle; different rack positions; different receptacles; different lighting conditions; etc. For supervised learning, the training set typically also includes tags for the images. The tags include the attributes to be trained: type of food, size of food/number of pieces of food, actual rack position, etc.

In typical training 312, a training sample is presented as an input to the machine learning model 220, which then produces an output for a particular attribute. The difference between the machine learning model's output and the known good output is used by the training module to adjust the values of the parameters in the machine learning model 220. This is repeated for many different training samples to improve the performance of the machine learning model 220.

The training module typically also validates 313 the trained machine learning model 220 based on additional validation samples. For example, the training module applies the machine learning model 220 to a set of validation samples to quantify the accuracy of the machine learning model 220. The validation sample set includes images and their known attributes. The output of the machine learning model 220 can be compared to the known ground truth. Common metrics applied in accuracy measurement include Precision=TP/(TP+FP) and Recall=TP/(TP+FN), where TP is the number of true positives, FP is the number of false positives and FN is the number of false negatives. Precision is how many outcomes the machine learning model 220 correctly predicted had the target attribute (TP) out of the total that it predicted had the target attribute (TP+FP). Recall is how many outcomes the machine learning model 220 correctly predicted had the attribute (TP) out of the total number of validation samples that actually did have the target attribute (TP+FN). The F score (F-score=2*Precision*Recall/(Precision+Recall)) unifies Precision and Recall into a single measure. Common metrics applied in accuracy measurement also include Top-1 accuracy and Top-5 accuracy. Under Top-1 accuracy, a trained model is accurate when the top-1 prediction (i.e., the prediction with the highest probability) predicted by the trained model is correct. Under Top-5 accuracy, a trained model is accurate when one of the top-5 predictions (e.g., the five predictions with highest probabilities) is correct.

The training module may use other types of metrics to quantify the accuracy of the trained model. In one embodiment, the training module trains the machine learning model until the occurrence of a stopping condition, such as the accuracy measurement indication that the model is sufficiently accurate, or a number of training rounds having taken place.

Training 310 of the machine learning model 220 can occur off-line, as part of the product development for the cooking appliance. The trained model 220 is then installed on the cooking appliances sold to consumers. The appliances can execute the machine learning model using fewer computing resources than is required for training. In some cases, the machine learning model 220 is continuously trained 310 or updated. For example, the training module uses the images captured by the camera 130 in the field to further train the machine learning model 220. Because the training 310 is more computationally intensive, it may be cloud-based or occur on a separate home device with more computing power. Updates to the machine learning model 220 are distributed to the cooking appliances.

In operation 320, the machine learning model 220 uses the images captured 321 by the camera 130 as input 322 to the machine learning model 220. In one architecture, the machine learning model 220 calculates 323 a probability of possible different outcomes, for example the probability that the food is beef, that the food is chicken, that the food is a vegetable, etc. Based on the calculated probabilities, the machine learning model 220 identifies 323 which attribute is most likely. For example, the machine learning model 220 might identify that beef rib is the most likely food type. In a situation where there is not a clear cut winner, the machine learning model 220 may identify multiple attributes and ask the user to verify. For example, it might report that beef rib and pork chop are both likely, with the user verifying that the food is beef rib. The controller 230 then controls 324 the cooking appliance based on the identified attributes.

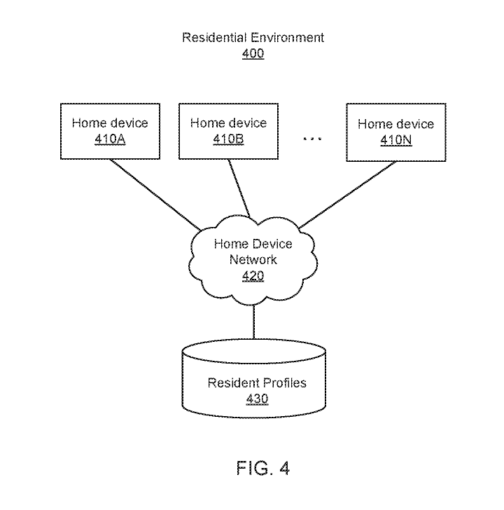

In another aspect, the cooking appliance may be part of a home network. FIG. 4 is a block diagram of a residential environment that includes a cooking appliance, according to an embodiment. The residential environment 400 is an environment designed for people to live in. The residential environment 400 can be a dwelling, such as a house, a condo, an apartment, or a dormitory. The residential environment 400 includes home devices 410A-N, including the cooking appliance described above. It also includes a home device network 420 connecting the home devices 410, and a resident profiles database 430 that contains residents' preferences for the home devices. The components in FIG. 4 are shown as separate blocks but they may be combined depending on the implementation. For example, the resident profiles 430 may be part of the home devices 410. Also, the residential environment 400 may include a hub for the network 420. The hub may also control the home devices 410. The network 420 may also provide access to external devices, such as cloud-based services.

The home devices 410 are household devices that are made available to the different persons associated with the residential environment 400. Examples of other home devices 410 include HVAC devices (e.g., air conditioner, heater, air venting), lighting, powered window and door treatments (e.g., door locks, power blinds and shades), powered furniture or furnishings (e.g., standing desk, recliner chair), audio devices (e.g., music player), video device (e.g., television, home theater), environmental controls (e.g., air filter, air freshener), kitchen appliances (e.g., rice cooker, coffee machine, refrigerator), bathroom appliances, and household robotic devices (e.g., vacuum robot, robot butler). The home devices 410 can include other types of devices that can be used in a household.

The resident profiles 430 typically include information about the different residents, such as name, an identifier used by the system, age, gender, and health information. The resident profiles 430 can also include settings and other preferences of the home devices 410 selected by the different residents.

The network 420 provides connectivity between the different components of the residential environment 400 and allows the components to exchange data with each other. The term “network” is intended to be interpreted broadly. It can include formal networks with standard defined protocols, such as Ethernet and InfiniBand. In one embodiment, the network 420 is a local area network that has its network equipment and interconnects managed within the residential environment 400. The network 420 can also combine different types of connectivity. It may include a combination of local area and/or wide area networks, using both wired and/or wireless links. Data exchanged between the components may be represented using any suitable format. In some embodiments, all or sonic of the data and communications may be encrypted.

The functionality described above can be physically implemented in the individual cooking appliance (one of the home devices 410), in a central hub for the home network, in a cloud-based service or else where accessible by the cooking appliance via the network 420.

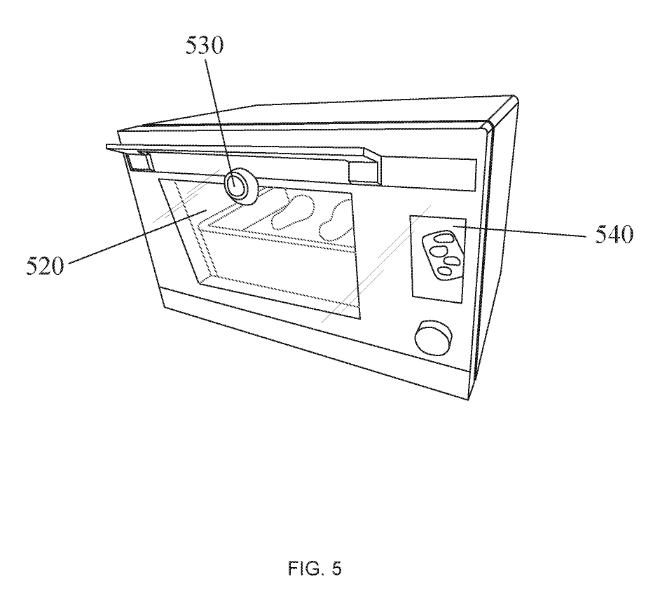

FIG. 5 is a photograph of a cooking appliance, according to an embodiment. This example is a countertop oven. The oven has a double pane front window 520. A camera 530 is located behind the bumper and between the two panes of the window 520. The machine learning model is implemented using electronics in the product. The oven connects to a home network. Training of the machine learning model occurs external to the appliance, and updates to the machine learning model can be received via the network. For example, the machine learning model might be initially trained to distinguish the following food types (listed in alphabetical order):
bacon roll
bacon strips
beef ribs
biscuit
caterpillar bread
chicken
chicken breast
chicken drumstick
chicken thigh
chicken wing
chiffon cake
cookie
corn
croissant
cup cake
drumette
egg tart
fish
lamb chops
moon cake
peanut
pizza
pork
pork ribs
potato, sweet potato
salmon
sausage
shrimp
squid
steak
toast
   The configuration of the machine learning model may be adjusted over time. Maybe the user does not eat chicken but does eat many different cuts of salmon: salmon fillet, salmon steak, salmon head, salmon neck collar, salmon chunks. The machine learning model does not have to recognize chicken but does have to recognize different cuts of salmon. An appropriate model may be downloaded to the oven.

In FIG. 5, the oven contains some chicken drumsticks. The camera captures images of the interior, the machine learning model identifies the food as chicken drumsticks, and this result is displayed on the front panel 540 of the oven. If it is incorrect, the user can make a correction. This can be used to further refine the machine learning model. The machine learning model can be optimized for the specific configuration for that model of oven. It can also he optimized over time for variations between specific units of that oven model.

Although the detailed description contains many specifics, these should not be construed as limiting the scope of the invention but merely as illustrating different examples. It should be appreciated that the scope of the disclosure includes other embodiments not discussed in detail above. For example, although an oven is used as the primary example, other cooking appliances can also be used. These include all varieties of ovens (counter top ovens, built-in ovens, toaster ovens, infrared ovens) in addition to steamers, microwaves, ranges and other cooking appliances. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

Alternate embodiments are implemented in computer hardware, firmware, software, and/or combinations thereof. Implementations can be implemented in a computer program product tangibly embodied in a machine-readable storage device for execution by a programmable processor; and method steps can be performed by a programmable processor executing a program of instructions to perform functions by operating on input data and generating output. Embodiments can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits and other forms of hardware.

1. A computer-implemented method for controlling a cooking appliance having a cook chamber, the method comprising:
capturing images viewing an interior of a cook chamber of the cooking appliance;
applying the captured images as inputs to a machine learned model, the machine learned model determining attributes of contents of the cook chamber, the contents including food to be cooked; and
controlling a cooking process for the food according to the determined attributes of the contents of the cook chamber.

2. The method of claim 1 wherein the machine learning model determines a type of food in the cook chamber and the cooking process is controlled based on the type of food.

3. The method of claim 2. wherein the machine learning model distinguishes between different types of meat and the cooking process is controlled based on the type of meat.

4. The method of claim 2 wherein, for at least one type of meat, the machine learning model distinguishes between different parts for that type of meat and the cooking process is controlled based on the part.

5. The method of claim 1 wherein the machine learning model determines a cooking load and the cooking process is controlled based on the cooking load.

6. The method of claim 5 wherein the machine learning model determines a thickness or volume of the food in the cook chamber and the cooking process is controlled based on the thickness or volume.

7. The method of claim 5 wherein the machine learning model determines a number of pieces for the food in the cook chamber and the cooking process is controlled based on the number of pieces.

8. The method of claim 1 wherein the machine learning model determines a position of a rack in the cook chamber and the cooking process is controlled based on the rack position.

9. The method of claim 1 wherein the contents of the cook chamber further includes a receptacle for the food, the machine learning model determines an attribute of the receptacle and the cooking process is controlled based on the attribute of the receptacle.

10. The method of claim 1 wherein controlling the cooking process for the food comprises controlling a temperature-time curve for the cooking appliance according to the determined attributes of the contents of the cook chamber.

11. The method of claim 1 wherein the cooking appliance has different cooking modes, and controlling the cooking process for the food comprises selecting a cooking mode for the cooking appliance according to the determined attributes of the contents of the cook chamber.

12. The method of claim wherein the cooking process has different phases, and controlling the cooking process for the food comprises transitioning between different phases according to the determined attributes of the contents of the cook chamber.

13. (canceled)

14. The method of claim 1 wherein the machine learning model further determines if no food is in the cook chamber, and the method further comprises providing notification if the cooking appliance is cooking when no food is in the cook chamber.

15. The method of claim 1 wherein the machine learning model further determines if food is in the cook chamber, and the method further comprises providing notification if the cooking appliance is preheating when food is in the cook chamber.

16. (canceled)

17. The method of claim 1 further comprising:
monitoring a temperature of the food, wherein the cooking process is controlled further according to the temperature of the food.

18. The method of claim 1 further comprising:
receiving input from the user about the food or the cooking process for the food, wherein the cooking process is controlled further according to the user input.

19. The method of claim 1 further comprising:
accessing a user's profile for information about the food or the cooking process for the food, wherein the cooking process is controlled further according to the information from the user's profile.

20. The method of claim 1 further comprising:
accessing a user's usage history for information about the food or the cooking process for the food, wherein the cooking process is controlled further according to the information from the user's usage history.

21. The method of claim 1 further comprising:
accessing historical data for the cooking appliance, wherein the cooking process is controlled further according to the historical data.

22. A cooking appliance comprising:
a cook chamber in which food is placed for cooking;
a camera positioned to view an interior of the cook chamber; and
a processing system that:
causes the camera to capture images of contents of the cook chamber, the contents including food to be cooked;
applies the captured images as inputs to a machine learned model, the machine learned model determining attributes of contents of the cook chamber; and
controls a cooking process for the food according to the determined attributes of the contents of the cook chamber.

23-29. (canceled)
